(19) United States
(12) Patent Application Publication
(10) Pub. No.: US 2006/0037045 A1
(43) Pub. Date: Feb. 16, 2006

(54) System and method for previewing and switching to favorite channels

(75) Inventor: Kuan-Hong Hsieh, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/198,434

(22) Filed: Aug. 5, 2005

(30) Foreign Application Priority Data
Aug. 14, 2004 (CN) 200410051158.8

(51) Int. Cl. H04N 7/16; H04N 5/445; H04N 7/173; G06F 13/00; G06F 3/00

(52) U.S. Cl. 725/43; 725/46; 725/100; 725/8

(57) ABSTRACT

A system for previewing and switching to favorite channels is employed to divide a screen (10) such as a TV screen into a main window (11) and a plurality of sub-windows (12, 13, 14) to display contents of programs of different channels. The sub-windows are used to display the contents of preset favorite channels, while the main window is used to display a content of a program of a current channel. The system includes a tuner (21), a decoder (22), an audio processor (23), an SOC (24), an EEPROM (25), a speaker (26), a display (27), a remote controller (28) and an infrared receiver (29). The SOC respectively connects with the tuner, the decoder, the audio processor, the EEPROM, the display and the infrared receiver. A related method is also provided.

### 1. FIELD OF THE INVENTION

The present invention relates to systems and methods for previewing and switching channels in multimedia entertainment systems, and particularly to a system and method for previewing and switching to favorite channels in a TV or like system.

### 2. GENERAL BACKGROUND

With the ongoing development of television technology, televisions are being equipped with more and more functions. For example, a user can control operation of the TV by infrared remote control, the user can adjust parameters of audio and video output of the TV through an on-screen display, and the user can view a picture in picture (PIP) display. In addition, the user can switch between transmissions of different modes. That is, the user can select to receive NTSC (National Television Standards Committee), PAL (Phase Alternate Line), or SECAM (Sequential Couleur Avec Memoire) transmissions.

Multi-menu television technology is gaining in popularity. An example of this type of television technology is found in China patent application No. 90102807.X. A plurality of television programs can be converted into a plurality of zoomed out menus, which are embedded in a plurality of windows. A transmitting station transmits the TV programs with multi-menus over a single channel. The audio signal of the TV programs broadcasts through the usual television audio channel or multi-channels. An ordinary television can receive the TV programs with multi-menus. However, a television user cannot define his/her favorite channels, and cannot change the contents of the received programs with multi-menus.

For the benefit of users, television manufacturers provide televisions with the function of pre-stored favorite channels. Users may select some channels as favorite channels and store the favorite channels. While watching a program, a user can directly switch to any of the favorite channels. However, the user usually does not know the actual current content that a favorite channel is broadcasting, and the user may not know when a desired program of a favorite channel is to be broadcast. In order not to miss a desired program, the user needs to switch television channels now and then.

Television manufacturers also provide televisions with the function of PIP. With PIP, one or more submenus are inserted into an appropriate location on the screen when a main menu is displayed. A user may search the favorite channels in the submenus while watching a current program. An example of this type of television technology is disclosed in China patent application no. 91100848.9. According to this prior art, a television with such PIP function includes a receiving circuit, a processing circuit, a controlling circuit, and an outputting circuit. The outputting circuit outputs television signals of both the main menu and the submenu. By using the receiving circuit, the processing circuit, the controlling circuit and the outputting circuit, signals are output to the screen. A user can simultaneously watch the program of the main menu and the program of submenu, and can change to any program of the submenu. However, the television needs two sets of receiving circuits and two sets of processing circuits. This makes the cost of the television commercially unattractive.

Thus, an improved system and method which overcome the above-mentioned problems are desired.

### SUMMARY

A system for previewing and switching to favorite channels (hereinafter, “the system”) in accordance with a preferred embodiment is provided herein. The system is adopted to divide a full screen window of a TV (or like device) into a plurality of windows, including a main window and a plurality of sub-windows. Such sub-windows are used to display pictures of favorite channels when the main window is displaying pictures of a current channel. The system includes a tuner, a decoder, an EEPROM (electrically erasable programmable read-only memory), a display, a previewing button for favorite channels, a switching button for favorite channels, a remote controller and a SOC (System on Chip). The tuner is used to receive radio signals and separates video signals from them. The decoder is used to receive the video signals and decode them. The EEPROM is used to store frequencies of the tuner corresponding to the favorite channels. The previewing button and the switching button of favorite channels are used to send the signals of previewing and switching favorite channels. The SOC is used to receive the signals of previewing and switching favorite channels and the decoded video signals, which deals with the signals and displays the pictures in the display. The SOC respectively connects the EEPROM and the tuner through a bus.

A method for previewing and switching to favorite channels in a TV (or like device) is also provided. The method includes the steps of: (a) pressing the previewing button of favorite channels and sending an infrared signal to an infrared receiver, which sends a code of a key-press to the SOC; (b) receiving the code of the key-press and sending a controlling signal to the display which is divided into a main window and a plurality of sub-windows; (c) reading the frequencies of the tuner corresponding to the favorite channels from the EEPROM and sending the frequencies to the tuner; (d) receiving the frequencies and processing radio signals under the new frequencies and obtaining the video signals at the tuner; (e) receiving the video signals of the favorite channel at the SOC and making the sub-windows as output, and displaying the pictures of favorite channels in sub-windows; (f) transmitting the frequency of the channel of the main window from the SOC to the tuner in order to receive the radio signals of the current channel and separate the video signals; and (g) receiving the video signals of the current channel at the SOC and making the main window as output, and displaying the programs of the current channel in the main window.

Other advantages and novel features will be drawn from the following detailed description of the embodiments with reference to the attached drawings, in which:

### BRIEF DESCRIPTION OF THE DRAWINGS

FIG. 1 schematically illustrates a divided full screen window of a TV in accordance with a preferred embodiment of the present invention;

FIG. 2 schematically illustrates different channels in the divided full screen window of FIG. 1 in accordance with the preferred embodiment of the present invention;

FIG. 3 is a block diagram of a system for previewing and switching to favorite channels of a TV in accordance with the preferred embodiment of the present invention;

FIG. 4 is a flow chart of a preferred method for previewing and switching to favorite channels of a TV by utilizing the system of FIG. 3; and

FIG. 5 is a block diagram of a system for previewing and switching to favorite channels of a TV in accordance with an alternative embodiment of the present invention.

### DETAILED DESCRIPTION OF THE EMBODIMENTS

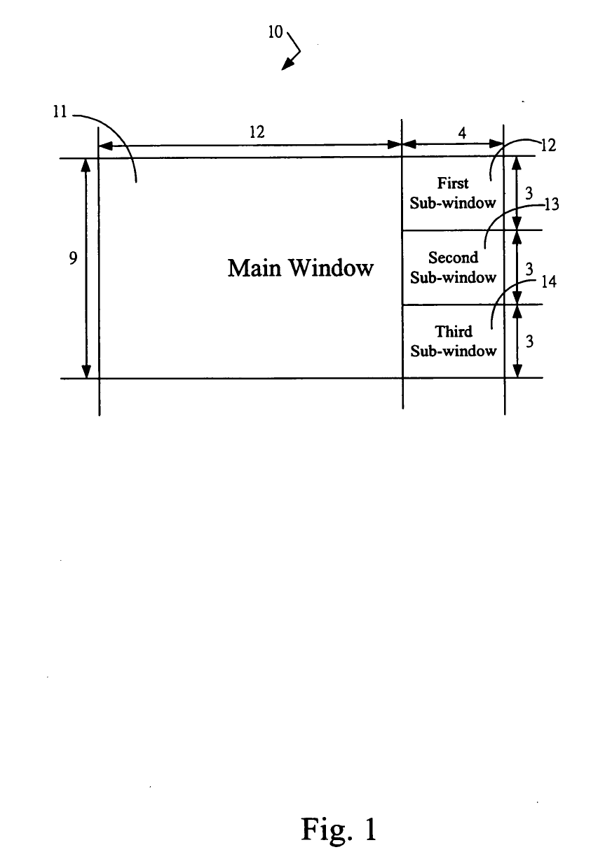

Referring now to the drawings, FIG. 1 schematically illustrates a divided full screen window 10 of a display device like a television (TV) in accordance with the present invention. Even though the following description refers to a TV for the purposes of illustrating the present invention, the present invention is not limited to this example. In other examples, a suitably enabled personal computer or other display device may equally be employed in practicing the present invention. In a preferred embodiment, the full screen window 10 has a length-to-width ratio of about sixteen units to nine units. When a user presses a previewing button (not shown) for favorite channels, the full screen window 10 is divided into a main window 11 having a length-to-width ratio of about twelve units to nine units, and a first sub-window 12, a second sub-window 13 and a third sub-window 14 each having length-to-width ratios of about four units to three units. That is, the main window 11 is about three times larger than each of the sub-windows 12, 13 and 14 in both length and width.

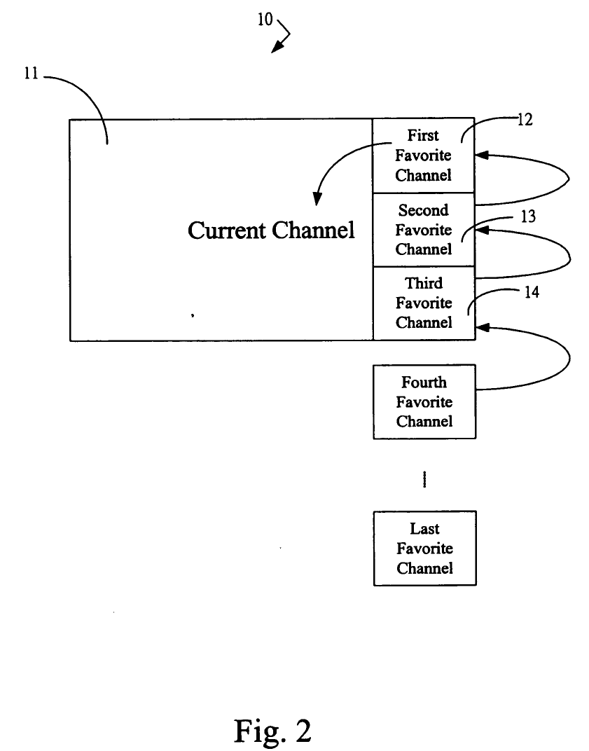

Referring also to FIG. 2, this schematically illustrates displaying of programs of different channels in the divided full screen window 10. As an example, suppose that the program of a particular channel (hereinafter referred to as “the current channel”) is being displayed on the window 10. If the user then presses the previewing button for the favorite channels, the program of the current channel is only displayed on the main window 11, and programs of three favorite channels (hereinafter respectively referred to as a “first favorite channel,” a “second favorite channel” and a “third favorite channel”) from the current channel onward in sequence (if they exist) are respectively displayed on the sub-windows 12, 13 and 14 according to the sequence of their channel numbers. The content displayed on the main window 11 are dynamic pictures. The content displayed on the sub-windows 12, 13 and 14 only are static pictures. The user can mainly learn the programs of the favorite channels according to the static pictures. The favorite channels are predetermined by the user or by the TV automatically. If the number of favorite channels is less than three, the program(s) of one or more non-favorite channels sequenced immediately after the current channel is/are displayed on any sub-window(s) that is/are not occupied by a favorite channel. In order to make the following description clear and simple, it will be assumed that there are more than three favorite channels. Nevertheless, the present invention should not be construed as to being limited to such particular situation. The present invention is equally applicable to other situations in which there are three or fewer favorite channels.

When the user subsequently presses a switching button for favorite channels, the program of the first favorite channel is transferred and displayed on the main window 11. The following favorite channels are advanced one place in sequence accordingly. That is, the program of the second favorite channel is transferred and displayed on the first sub-window 12, the program of the third favorite channel is transferred and displayed on the second sub-window 13, and the program of a fourth favorite channel is displayed on the third sub-window 14. Further, the current channel is moved to the end of the sequence of favorite channels if it is a favorite channel, or goes back into the numerical sequence of channels in its correct place if it is not a favorite channel.

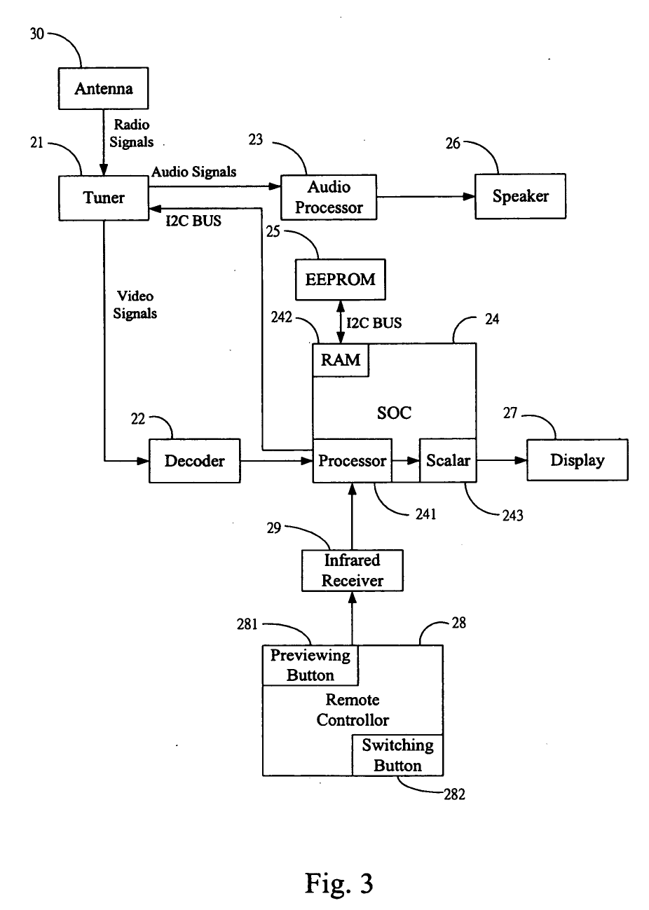

Referring to FIG. 3, this is a block diagram of a system for previewing and switching to favorite channels of a TV (hereinafter, “the system”) according to the preferred embodiment of the present invention. The system includes a tuner 21, a decoder 22, an audio processor 23, an SOC (System on Chip) 24, an EEPROM (electrically erasable programmable read-only memory) 25, a speaker 26, a display 27, a remote controller 28, and an infrared receiver 29. The tuner 21 respectively connects with the decoder 22, the audio processor 23, and the SOC 24. The SOC 24 connects with the tuner 21, the decoder 22, the EEPROM 25, the display 27 and the infrared receiver 29, and controls each of the tuner 21 and the EEPROM 25 through an I2C (Inter-Integrated Circuit) bus.

The tuner 21 receives radio signals from an antenna 30, and separates the radio signals into video signals and audio signals. The video signals are sent to the decoder 22 to be decoded before being input into the SOC 24, and the audio signals are sent to the audio processor 23 and then are broadcasted through the speaker 26. The EEPROM 25 is for storing corresponding frequencies of the favorite channels. The SOC 24 comprises a processor 241, a RAM 242, and a scalar 243. The processor 241 is used to process the received video signals. The RAM 242 is used to store frequencies of three most recently watched channels. The scalar 243 is used to control the display 27, and divide the full screen window 10 of the display 27 into the main window 11 and the three sub-windows 12, 13 and 14. The processor 241 obtains a corresponding frequency of a favorite channel from the EEPROM 25, and sends it to the tuner 21. The tuner 21 receives the new frequency, switches to the new frequency, and receives the radio signals from the antenna 30 under the new frequency.

The remote controller 28 has a previewing button 281 and a switching button 282 installed thereon for selecting favorite channels. As described above in relation to FIGS. 1 and 2, the previewing button 281 is operable for previewing programs of the favorite channels on the sub-windows 12, 13, 14, and the switching button 282 is operable for switching a current channel to a first favorite channel. Each time a user press the previewing button 281, a signal for previewing favorite channels is received by the processor 241 through the infrared receiver 29, and the processor 241 controls the tuner 21 to switch to corresponding favorite channels according to the signal. Accordingly, the display of the program of the current channel is stopped, and the contents of the programs of the corresponding favorite channels are displayed on the three sub-windows 12, 13 and 14 of the display 27. If the user presses the switching button 282, a signal for switching to the favorite channels is received by the processor 241, and the processor 241 changes the favorite channel on the first sub-window 12 to be the current channel. Accordingly, the scalar 243 controls the program of the first favorite channel to be displayed on the main window 11.

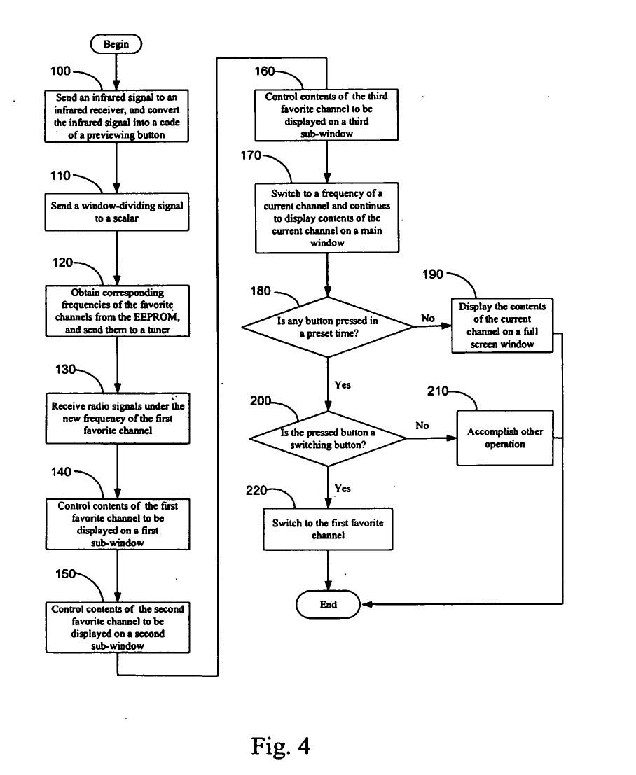

Referring to FIG. 4, this shows a preferred method for previewing and switching to favorite channels of a TV. The method comprises the following steps:

Step 100: A user presses the previewing button 281 of the remote controller 28 to send an infrared signal to the infrared receiver 29, while the program of a current channel is displayed on the full screen window 10 of the TV. The infrared receiver 29 converts the infrared signal of the previewing button 281 into a code, and sends the code to the processor 241. Simultaneously, the infrared receiver 29 sends an interrupt signal to stop execution of a current thread of the processor 241.

Step 110: The processor 241 sends a window-dividing signal to the scalar 243 according to the code, and the scalar 243 divides the full screen window 10 into the main window 11, the first sub-window 12, the second sub-window 13 and the third sub-window 14 according to the window-dividing signal. Simultaneously, the program of the current channel is displayed only on the main window 11.

Step 120: The processor 241 obtains corresponding frequencies of favorite channels from the EEPROM 25, and sends the frequencies to the tuner 21.

Step 130: The tuner 21 switches to the frequency of the first favorite channel. Accordingly, the display of the program of the current channel on the main window 11 is stopped. The tuner 21 receives radio signals under the frequency of the first favorite channel, and sends video signals to the SOC 24 through the decoder 22.

Step 140: The SOC 24 receives the video signals, and outputs them to the display 27. The scalar 243 controls the program of the first favorite channel to be displayed on the first sub-window 12, with the channel number thereof being displayed in a top right corner of the first sub-window 12.

Step 150: After the appearance of the program of the first favorite channel on the first sub-window 12, the system displays the program of the second favorite channel on the second sub-window 13, with the channel number thereof being displayed in a top right corner of the second sub-window 13. This is accomplished in similar fashion to the procedures described above in Step 120 through Step 140.

Step 160: After the appearance of the program of the second favorite channel on the second sub-window 13, the system displays the program of the third favorite channel on the third sub-window 14, with the channel number thereof being displayed in a top right corner of the third sub-window 14. This is accomplished in similar fashion to the procedures described above in Step 120 through Step 140.

Step 170: After the appearance of the program of the third favorite channel on the third sub-window 14, the tuner 12 switches to the frequency of the current channel, and the SOC 24 resumes displaying the program of the current channel on the main window 11.

Step 180: The processor 241 detects whether any button is pressed within a preset time after the tuner 12 has switched back to the frequency of the current channel.

Step 190: If no button is pressed within the preset time according to step 180, the processor 241 controls the scalar 243 to display the program of the current channel on the full screen window 10, whereupon the procedure is finished.

Step 200: If any button is pressed within the preset time according to step 180, the processor 241 determines whether the button is the switching button 282 for changing to a favorite channel.

Step 210: If the pressed button is not the switching button 282 according to step 200, the system performs the necessary operations corresponding to the pressed button, whereupon the procedure is finished.

Step 220: If the pressed button is the switching button 282 according to step S200, the TV is switched to the first favorite channel. The processor 241 controls the scalar 243 to display the program of the first favorite channel on the main window 11, the program of the second favorite channel on the first sub-window 12, the program of the third favorite channel on the second sub-window 13, and the program of the fourth favorite channel on the third sub-window 14. That is, the favorite channels are each advanced one place. Further, the current channel is moved to the end of all the favorite channels or goes back into the numerical sequence of channels in its correct place, depending on whether the current channel is a favorite channel or a non-favorite channel.

During any applicable of the above-mentioned steps, after the program of any of the favorite channels is displayed on any of the sub-windows 12, 13 and 14, the user may directly switch the TV to a desired favorite channel according to the channel number displayed in the top right corner of the sub-window 12, 13 or 14.

According to the above-described method, the user can preview the favorite channels while the content of the program of the current channel is displayed on the main window 11, and switch to the favorite channels directly if desired.

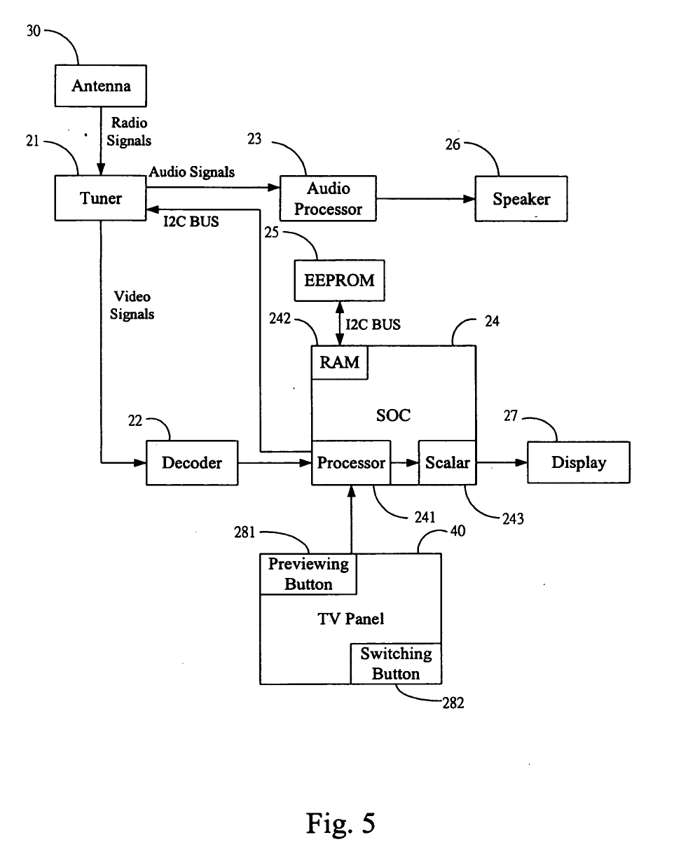

Referring to FIG. 5, this is a block diagram of a system for previewing and switching to favorite channels of a TV accordance to the alternative embodiment of the present invention. The system of the alternative embodiment is the same as that of the preferred embodiment, except that the remote controller 28 is replaced by a TV panel 40. The TV panel 40 has the previewing button 281 and the switching button 282 installed thereon.

The invention is also applicable for previewing and switching to non-favorite channels. While watching the program of a current channel, the user can press the previewing button 281, whereupon the full screen window 10 is divided into the plurality of windows 11, 12, 13, 14. Thereupon, the main window 11 displays the program of the current channel, and the sub-windows 12, 13 and 14 respectively display programs of three channels whose channel numbers, predefined by the TV program providers, are next in sequence to the current channel. Alternatively, the most recently watched channels stored in the RAM 242 are also capable of being displayed in the same way.

It is to be understood, however, that even though numerous characteristics and advantages of the present invention have been set forth in the foregoing description, together with details of the structure and function of the invention, the disclosure is illustrative only, and changes may be made in detail, especially in matters of type and arrangement of components within the principles of the invention to the full extent indicated by the general meaning of the terms in which the appended claims are expressed.

We claim:

1. A system for previewing and switching to favorite channels, the system comprising:
a tuner which receives radio signals from an antenna and separates the radio signals into video signals and audio signals;
a decoder which decodes the video signals from the tuner;
a System on Chip (SOC) which receives the video signals from the decoder and outputs the video signals to a display screen;
an electrically erasable and programmable read-only memory (EEPROM) which stores frequencies of favorite channels;
a controller which sends signals for previewing and switching channels;
an infrared receiver which receives the signals for previewing and switching channels, converts the signals to codes of buttons, and sends the codes to the SOC; and
a scalar which changes the screen into a divided screen;
wherein the SOC connects with the tuner, the decoder, the EEPROM, the screen, and the infrared receiver.

2. The system for previewing and switching to favorite channels as claimed in claim 1, further comprising an audio processor which receives the audio signals from the tuner, processes the audio signals, and sends the processed audio signals to a speaker.

3. The system for previewing and switching to favorite channels as claimed in claim 1, wherein the SOC respectively controls each of the tuner and the EEPROM through an Inter-Integrated Circuit (12C) bus.

4. The system for previewing and switching to favorite channels as claimed in claim 1, wherein the SOC comprises a processor, a random-access memory (RAM), and a scalar.

5. The system for previewing and switching to favorite channels as described in claim 4, wherein the RAM stores frequencies of three channels recently watched by one or more users.

6. The system for previewing and switching to favorite channels as claimed in claim 1, wherein the controller has a previewing button and a switching button for receiving commands for previewing and switching to favorite channels.

7. A method for previewing and switching to a favorite channel, the method comprising:
receiving a command for previewing one or more favorite channels and sending a corresponding infrared signal to an infrared receiver, while a content of a current channel is being displayed on a display screen;
converting the infrared signal into a code, and sending the code to a system on chip (SOC);
controlling a scaler to divide the screen into a main window and one or more sub-windows, and displaying the content of the current channel on the main window;
obtaining one or more frequencies of the favorite channels from an electrically erasable and programmable read-only memory (EEPROM), and respectively sending the frequencies to a tuner;
receiving one or more radio signals under the frequencies of the favorite channels, stopping the displaying of the content of the current channel on the main window, and displaying a content or contents of the favorite channels on the sub-windows;
sending a frequency of the current channel to the tuner, and receiving radio signals under the frequency of the current channel;
displaying the content of the current channel on the main window; and
receiving a command for switching to a favorite channel, and causing a content of the favorite channel to be displayed on the main window.

8. The method as claimed in claim 7, wherein one or more channel numbers of the favorite channels are displayed in the sub-windows.

9. The method as claimed in claim 7, wherein the content of the favorite channel is displayed on the main window only if the command for switching to the favorite channel is received within a preset time after the commencement of displaying of the content of the current channel on the main window.

10. The method as claimed in claim 9, wherein the screen displays only the content of the current channel if the command for switching to the favorite channel is not received within the preset time.

11. A method for previewing and switching television channels on a display device, the method comprising the steps of:
retrieving a preset sequence of predefined television channels;
retrieving program signals of prior ones of said predefined television channels according to said preset sequence;
displaying programs of said prior ones of said predefined television channels simultaneously and respectively on different, corresponding display windows of said display device based on said retrieved program signals; and
switching display of at least one of said prior ones of said predefined television channels to another of said display windows from an original display window thereof in said displaying step.

12. The method as claimed in claim 11, wherein said sequence is a predefined favorite-channel sequence.

13. The method as claimed in claim 11, wherein said sequence is a predefined most-recently-watched-channel sequence.

14. The method as claimed in claim 11, wherein said sequence is a predefined channel sequence from television program providers.

15. The method as claimed in claim 11, wherein said display windows of said display device include a main window having a larger occupied area on a full screen window of said display device, and at least two sub-windows having a smaller occupied area on said full screen window than said main window.

16. The method as claimed in claim 15, wherein said display of said at least one of said prior ones of said predefined television channels is switched from one of said at least two sub-windows, as said original display window thereof, to said main window, as said another of said display windows, in said switching step.
